(19) United States
(12) Patent Application Publication
(10) Pub. No.: US 2008/0251690 A1
(43) Pub. Date: Oct. 16, 2008

(54) LED luminaire with stabilized luminous flux and stabilized light color

(75) Inventors: Oliver Keiper, Aarbergen (DE); Juergen Meinl, Hohenstein (DE); Armin Plichta, Sponheim (DE)

Correspondence Address: DEMONT & BREYER, LLC, 100 COMMONS WAY, Ste. 250, HOLMDEL, NJ, 07733, US

(73) Assignee: SCHOTT AG, Mainz (DE)

(21) Appl. No.: 12/104,282

(22) Filed: Apr. 16, 2008

(30) Foreign Application Priority Data
Apr. 16, 2007 (DE) 10 2007 018 224.6

(51) Int. Cl. G01J 1/32

(52) U.S. Cl. 250/205

(57) ABSTRACT

The invention relates to an LED luminaire in which LEDs in three colors are provided and each LED is assigned a photodiode for measuring the luminous intensity of the individual LEDs. In order to produce a measurement window, two LEDs in each case are switched off.

### FIELD OF THE INVENTION

The invention relates to an LED luminaire, an arrangement having at least one LED luminaire, and a method for controlling an LED luminaire.

### BACKGROUND OF THE INVENTION

LED (light emitting diode) luminaires are known. In order to be able to provide LED luminaires having white light, one instance involves the use of blue LEDs with a phosphating. White light LEDs of this type have the disadvantage of a comparatively low efficiency, and that the light power decreases as the operational time increases.

In order to provide a white light luminaire, it is known, moreover, to mix the light of different-colored LEDs, in particular red, green and blue LEDs, in such a way that a color temperature is produced which can assume virtually any desired regions of the visible spectrum. In particular, a white light luminaire can be provided by mixing the light from red, yellow and blue LEDs. A method of this type is known for example from U.S. Pat. No. 3,760,174 (inventors Robert Boenning and Anthony Nasuta). In this case, the light of different colored LEDs is mixed and different colors are produced by means of a control of the individual LEDs. EP 1 348 319 B1 (inventors Subramanian Muthu, Chin Chang) discloses, in an array of LEDs having three colors, switching off the LEDs of one color and measuring the luminous flux of the remaining LEDs during the switch-off phase. The luminous flux of the switched-off LEDs can be determined by means of a difference determination. What is disadvantageous about this method is the extremely high control complexity and the relatively low accuracy of the method.

Finally, EP 1 056 993 B1 (inventors Michael Pashley, Thomas Marschall) shows an LED luminaire and also a method for setting the color temperature of an LED luminaire, in which the luminous flux of all the LEDs can be measured via a photodiode. In order to set a color equilibrium, a measurement pulse is generated in which the photodiode only measures the light power of one color. Thus, the light powers of all the LEDs can be compared with one another and the electric current for the respective LED can be set on the basis of this comparison. An LED white light luminaire can be provided by means of this method.

### OBJECT OF THE INVENTION

Against this background, the invention is based on the object of at least reducing the stated disadvantages of the prior art and of providing an LED luminaire and a method for controlling an LED luminaire in which the control accuracy is improved.

In particular, it is an object of the invention to control the color temperature of an LED luminaire so accurately that even in an arrangement of a plurality of luminaires arranged one after another and/or alongside one another, no or at most small color differences are noticeable to the human eye.

A further object of the invention is to provide an LED luminaire in which the light power is as uniform as possible over the entire lifetime, such that, in particular in an arrangement of a plurality of luminaires, individual luminaires can be exchanged without any visible difference in brightness.

A further object of the invention is to provide a white light LED luminaire which can be controlled with little complexity.

Furthermore, the construction costs for an LED luminaire are intended to kept low according to the invention.

### SUMMARY OF THE INVENTION

The object of the invention is already achieved by means of a luminaire, by means of an arrangement having a luminaire and also by means of a method for controlling an LED luminaire according to one of the independent claims.

Preferred embodiments and developments of the invention can be gathered from the respective subclaims.

The invention provides a luminaire having at least in each case one LED in three different colors, in particular in a RGB (red, green, blue) arrangement. The luminaire has means for controlling current fed to the LEDs for the LEDs of each color.

Furthermore, the luminaire has at least three photodiodes, wherein each photodiode is designed for measuring the luminous flux of a color.

Specifically, the luminaire comprises three LEDs in the colors red, green and blue, and also three photodiodes respectively assigned to the LEDs. According to one development, a plurality of LEDs can also be provided for increasing the light power for one or a plurality of colors.

Furthermore, the luminaire comprises means for occasionally switching off two colors in each case, wherein during the switch-off time the luminous intensity of the remaining color can be measured by means of the assigned photodiode. In order to determine the luminous flux of each color, therefore, there are measuring intervals in which only one color is switched on, such that the luminous flux of each color can be measured separately. According to the invention, in this case each color is assigned a photodiode. This has the advantage that the photodiode can be adapted in terms of its characteristic curve to the respective light color. Thus, by way of example, for measuring the red light component, it is possible to use a photodiode which has a particularly high sensitivity in the red range.

Furthermore, the luminaire has means for comparing the luminous intensities with one another and/or with desired luminous intensities, and means for setting an electric current for one LED, preferably for all the LEDs, on the basis of the comparison.

Proceeding from the luminous flux of the individual LEDs it is possible, therefore, to set an exact color temperature. In this case, in one instance provision is made for comparing the luminous intensities of the individual colors with one another. By means of a stored reference relation, it is possible to set a desired color temperature with high accuracy.

Measured luminous intensity in the sense of the invention is not taken to mean an absolute value, rather it suffices to measure the relative luminous intensity at any desired location, which is substantially proportion to the luminous flux emitted by an LED.

Furthermore, according to the invention, the luminous intensity of the individual colors and/or the total luminous intensity can be compared with one or a plurality of predetermined reference values or reference ranges.

Thus, besides the color temperature, it is also possible to control the luminous flux of the entire luminaire. Provision is made, for example, for operating the LEDs of a new luminaire with a reduced power rather than with maximum power. An attenuation of the emitted luminous flux that is brought about by aging can then be compensated for by increasing the power.

In one development of the invention, LEDs and photodiodes are embedded in a transparent potting composition. A compact, robust luminous module can thus be provided. The potting composition used is preferably a plastic in which the transparency is maintained over a longest possible period of time despite the irradiation with light. In particular, a silicone is provided as potting composition.

In one development of the invention, the photodiodes have a substantially light-opaque covering that is spaced apart. Said covering can in particular be embedded in the potting composition or be applied on the potting composition.

The covering reduces the penetration of light at least in the visible region and thus reduces disturbances caused by scattered light entering from the outside.

At the same time, the covering can be formed in light-scattering fashion or in reflective configuration on the underside, that is to say the side facing the photodiode. Light which is emitted by the LEDs is thus reflected in the direction of the photodiode. Preferably, the covering is formed in light-scattering fashion in this case. What is thereby achieved is that the light from the LEDs is applied uniformly to the photodiodes and regular patterns do not occur.

As an alternative or in combination, an optical waveguide leading from the photodiode to at least one LED can also be embedded. In particular, it is provided that light which is emitted laterally from the LED without emerging from the luminaire, and is therefore lost anyway for the most part as scattered light, is used for driving the photodiodes.

In one development of the invention, the luminaire has means for calibrating the light color and/or the light power.

Said means can comprise for example a data memory in which reference values for luminous intensity and ratio of light colors are stored. Provision is made, in particular, for configuring the data memory as a writable EPROM. Thus, by way of example, the new luminaire can be calibrated with regard to luminous intensity and light color. The values or ranges of values determined during calibration are written to the data memory and a luminaire having very high accuracy with regard to required color temperature and luminous intensity is thus provided since tolerances of the imprecisely constructed LEDs, of the imprecisely constructed photodiodes, etc. are eliminated by the calibration. However, it is also possible to perform the calibration on the basis of predetermined values, without carrying out an individual measurement for each luminaire.

In one preferred embodiment of the invention, the photodiodes are connected via an analog-to-digital converter to the comparison means. In particular, provision is made for using a multichannel analog-to-digital converter via which signals of all three photodiodes are processed further. Said analog-to-digital converter can also form an integrated circuit together with a control device for controlling the luminous flux of the individual LEDs.

The signal of the photodiode is preferably processed further via an amplifier, in particular via an operational amplifier. The signal of the operational amplifier can be forwarded directly to an analog-to-digital converter. In this case, the operational amplifier is formed as a current follower. This means that no countervoltage, which can lead to noise, for example builds up and a particularly fast measurement is possible.

In one preferred embodiment of the invention, LEDs and photodiodes are arranged on a printed circuit board. A particularly compact luminous module can thus be provided. In one preferred embodiment of the invention, the control device is also situated on the printed circuit board.

In one development of the invention, the luminaire can be switched into different colors. In addition to a use as a white light lamp, the luminaire can thus also perform other tasks, in particular as mood light, as path lighting in a means of transport, in particular an aircraft, or as emergency lighting.

In one development of the invention, at least one LED, preferably all the LEDs, has a lens which concentrates the light in a preferred direction.

In one development of the invention, at least one photodiode, preferably all the photodiodes, has a color filter. Although color filters of this type have the disadvantage of being relatively expensive, such that color filters of this type are explicitly dispensed with in one embodiment of the invention, on the other hand a color filter results in a high selectivity of the photodiode with respect to the light of the assigned LED and increases the accuracy of the control.

According to the invention, a luminaire can be provided which reaches a maximum housing temperature of 55° C. at an ambient temperature of 25° C.

In one development of the invention, a temperature sensor is assigned to the LEDs. Since the color temperature changes with the temperature of the LEDs, even more accurate control of the light color is possible by means of a temperature sensor of this type. For this purpose, the temperature sensor is connected to a control device. Provision is made, in particular, for providing a luminaire in which a calibration of the luminous intensity and color temperature by means of the photodiodes is performed only at relatively slow intervals, while the temperature is monitored throughout operation and the conduction of the LED is continuously readjusted according to the temperature. An adaptation of the color temperature and luminous intensity on account of aging phenomena of the LEDs is necessary only relatively infrequently. It suffices here, for example, for a corresponding adaptation to be performed at intervals of less than one minute, for example once per day. By contrast, the temperature changes relatively rapidly, in particular after the LEDs have been switched on, and in the absence of corresponding control leads to visible changes in the color temperature.

In one preferred embodiment of the invention, the calibration values relating to temperature and/or luminous intensity of the individual LEDs can be stored in the memory, in particular an EPROM. The storage is performed preferably in the form of families of characteristic curves.

The invention furthermore relates to an arrangement comprising a luminaire according to the invention. Preferably, a plurality of luminaires are arranged in a series and/or on an area. The control according to the invention of color temperature and/or light intensity makes it possible to provide an array of luminaires having a homogeneous appearance. In particular, an arrangement of this type can serve as a replacement for fluorescent tubes.

In this case, the luminaires preferably have a common voltage supply and are connected to one another in particular via a line.

In one development of the invention, the luminaires have a switch that can be actuated via a lead, in particular a data bus. Thus, the luminaires can be switched externally. A switch is understood not just to mean a switch with which a luminaire can be switched on and off, rather provision is also made for controlling light color, brightness, etc. by means of a switch of this type.

In a further preferred embodiment of the invention, the arrangement comprises an active or passive power factor correction control in order to minimize disturbances due to harmonics.

The invention furthermore relates to a method for controlling an LED luminaire having LEDs in three different colors. In accordance with the method, the LEDs in two colors in each case are switched off and the luminous intensity of the remaining color is measured during the switch-off time by means of an assigned photodiode. Therefore, at least three photodiodes are provided. Power control is performed by means of a comparison of the luminous intensity with a desired luminous intensity and/or the luminous intensity of the LEDs of the other colors, the luminous flux of the individual LEDs being controlled by means of said power control.

A precise adaptation of color temperature and light intensity is thus possible.

Preferably, the LEDs are operated in pulsed operation. A setting of the power of the LEDs by means of pulsed operation, that is to say the ratio of pulse lengths and pulse intermissions, enables particularly simple power control, in particular by means of integrated semiconductor components.

In this case, the frequency in pulsed operation is above 30, preferably above 50 and particularly preferably above 80 Hz.

Thus, the switching on and off of the LEDs is not visible to the human eye and a flicker-free luminaire can be provided.

In one development of the invention, all the LEDs are switched off occasionally, that is to say at specific measurement intervals, and a dark measurement is carried out. By means of a dark measurement, the proportion of scattered light can be determined and taken into account in the power control.

Thus, preferably the total light power of the luminaire is controlled to a predetermined desired range or desired value.

In one development of the invention, the LEDs of a new luminaire are operated with less than 70, preferably less than 60 and particularly preferably less that 55% of their maximum power. When using power control by means of pulsed operation, in the new state the LEDs are thus in operation less than 55% of the time. A new luminaire is understood to mean, in particular, a luminaire in which the LEDs had a switch-on time of less than 100 hours. In the course of aging of the luminaire, compensation of the reduced light power can thus be achieved by extending the pulse widths. A luminaire which, in the course of its lifetime, does not lose or loses hardly any light power can thus be provided. This is particularly advantageous if the luminaire is used in an arrangement according to the invention. This is because it is thus possible to exchange individual luminaires without the appearance of the entire arrangement changing, since color temperature and luminous flux are kept in a predetermined desired range.

In one development of the invention, the photodiodes are used for monitoring a space. In particular, the photodiodes are used as motion and/or fire detectors. Such a use of the photodiodes is possible, in particular, during the dark measurement. Thus, a change in the dark field values of the individual photodiodes which takes place in a relatively short time from one measurement interval to the next can be used to infer an object moving through a space. Flickering red and yellow components of the ambient light that arise in particular during fires can also be detected by the photodiodes and processed further by means of suitable evaluation electronics.

In addition to control by means of the photodiodes, one development of the invention additionally has temperature-controlled control in which the temperature of the individual LEDs is taken into account in the power control.

The invention furthermore relates to an LED luminaire having LEDs in three different colors, means for feeding electric current to the LEDs, and means for controlling the electric current for the LEDs of each color. The luminaire has at least two, preferably three photodiodes, wherein preferably each color is assigned a photodiode, and means for occasionally switching off two colors in each case. During the switch-off time, the luminous intensity of the remaining color can be measured by means of an assigned photodiode and the luminaire has means for comparing the luminous intensities with one another or with predetermined desired luminous intensities. The power of the individual LEDs is controlled on the basis of this comparison, whereby a white light lamp can be provided.

According to the invention, the luminaire is furthermore formed in such a way that the signal of the non-assigned LED is also measured and the luminaire has means for switching off or for fault indication.

By reading out the signals of the non-assigned photodiodes in a measurement interval, it is possible to draw conclusions as to whether for example an LED or a photodiode has failed.

During the measurement, light of the individual switched-on color is applied to all the photodiodes. If a photodiode has failed, this can be discerned from the fact that only this individual photodiode supplies no signal or a signal outside a predetermined range of values. In this case, preferably, the luminaire can be switched into an operating state with constant power. The control is therefore switched off and the luminaire is operated for example on the basis of the last control. A fault signal can simultaneously be generated.

If the LED in one color has completely failed, this can be determined by the fact that during the assigned measurement interval, the signal of all the photodiodes lies below a predetermined threshold value. In this case, the luminaire can be switched off and a fault indication can be generated. In this case, the fault indication can also comprise an optical signal of the luminaire itself; by way of example, a flashing signal can be generated or the luminaire can be switched into a different color.

The luminaire according to the invention is provided in particular for use as space lighting in an aircraft or vehicle. At the same time, by means of a corresponding control, a luminaire of this type, in particular an arrangement comprising luminaires according to the invention, can be used as moving light.

The luminaires according to the invention have the advantage that color and brightness can be set within a wide range. Thus, a plurality of tasks, such as space lighting, reading light, night light, etc., can be performed by a single luminaire or a single luminous system.

The invention furthermore relates to a luminaire having at least in each case one LED in three different colors, means for feeding electric current to the LEDs, means for controlling the electric current for the LEDs of each color, at least one photodiode for measuring the luminous intensity of at least one LED, and means for setting the electric current for at least one LED, preferably all the LEDs. According to the invention, the luminaire has a covering spaced apart from the photodiode, in order to reduce disturbing influences caused by entering ambient light.

The covering is spaced apart from the photodiode preferably between 0.5 and 10 mm, particularly preferably between 1 and 5 mm.

### BRIEF DESCRIPTION OF THE DRAWINGS

The invention will be explained in more detail referring to schematically illustrated exemplary embodiments on the basis of the drawings, FIG. 1 to FIG. 9.

FIG. 1 schematically shows an exemplary embodiment of a luminaire according to the invention,

FIG. 2 schematically shows a control circuit for a color of a luminaire according to the invention,

FIG. 3 schematically shows the driving of the LEDs,

FIG. 4 shows a schematic sectional view of an exemplary embodiment of a luminaire according to the invention,

FIG. 5 shows a schematic flowchart of an exemplary embodiment of a method for controlling an LED luminaire,

FIG. 6 schematically shows a further flowchart, on the basis of which the control of an LED luminaire is elucidated,

FIG. 7 schematically shows an arrangement comprising a plurality of luminaires,

FIG. 8 schematically shows a further exemplary embodiment of a luminaire,

FIG. 9 schematically shows the part of a control circuit.

### DETAILED DESCRIPTION OF PREFERRED EMBODIMENTS ON THE BASIS OF THE DRAWINGS

An exemplary embodiment of a luminaire 1 will be explained in greater detail referring to the schematic illustration of FIG. 1.

The luminaire 1 comprises a circuit board 2, which is divided into four zones. On three zones there is situated in each case one LED in the colors red 3, green 4 and blue 5. By means of these LEDs 3, 4, 5, the light of which is mixed for example in a downstream light mixer (not illustrated), light can be generated in different colors. In particular, the luminaire 1 can be used as a white light luminaire.

In order to be able to control the luminous flux of the LEDs 3, 4, 5, each LED is assigned a photodiode 6, 7, 8. In this case, the photodiodes 6, 7, 8 are arranged in the remaining fourth zone of the circuit board 2. Thus, the red LED 3 is assigned the photodiode 6, the green LED 4 is assigned the photodiode 7 and the blue LED 5 is assigned the photodiode 8. In this case, the photodiodes 6, 7, 8 are distributed such that they lie as close as possible to the respectively assigned LED. Furthermore, a ridge 9 is also provided on the circuit board 2, around the photodiode 7, said ridge likewise having the task of ensuring that the light of the LEDs 3, 4, 5 is preferably applied to the respectively assigned photodiode 6, 7, 8.

It goes without saying, however, that despite the geometrical arrangement and despite the ridge 9, the light of each of the LEDs 3, 4, 5 impinges on all the photodiodes 6, 7, 8. In order to enable exact control, therefore, for the measurement of the luminous intensity of the respective LEDs 3, 4, 5, two LEDs are switched off and in this case the light of the remaining switched-on LED is measured by means of the assigned photodiode. This embodiment makes it possible to use photodiodes 6, 7, 8 whose measurement window is coordinated with the respective light color. When measuring the luminous intensity of one color, it is even possible to achieve an additional function by means of the remaining photodiodes assigned to the other LEDs.

If the signal of an assigned photodiode lies below a predetermined threshold value, for example, it can be deduced that either the assigned LED or the photodiode is defective. Whether a defect of the photodiode or of the LED is present can be determined by reading out the signal of the remaining photodiodes. Since the light of the light color to be measured is also applied to the remaining photodiodes, the signal thereof must also lie above a predetermined threshold value, otherwise the LED is defective. If, by contrast, the signal lies above a predetermined threshold value, it can be assumed that the photodiode is defective. In the case of a defect of a photodiode, the luminaire can be set to an emergency operation mode, in which the luminous flux of the individual LEDS 3, 4, 5 is no longer set by means of the control circuit (not illustrated).

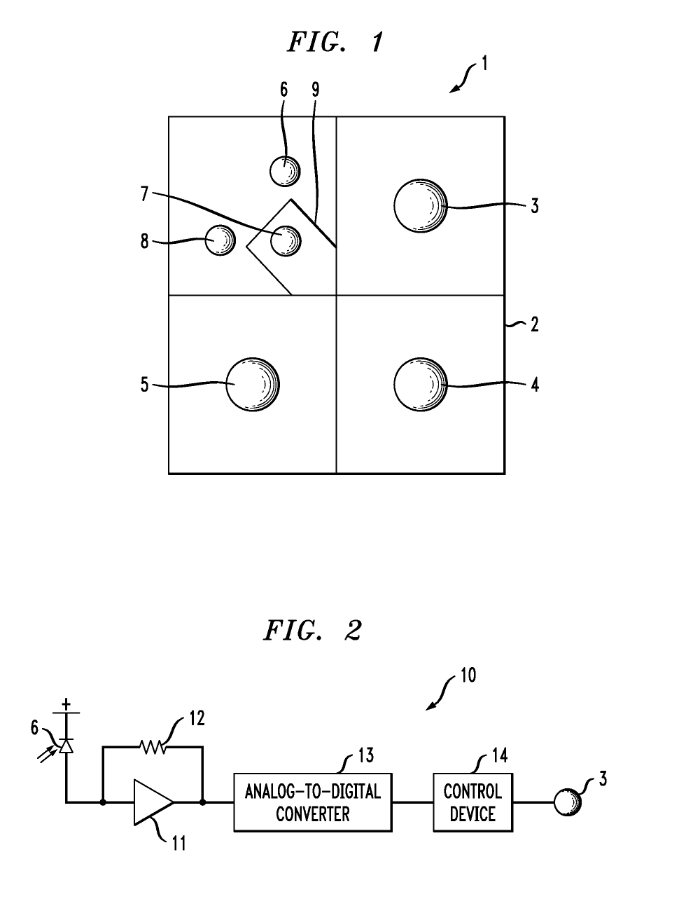

An exemplary embodiment of a control circuit 10 for one channel, here for the light color red, will be explained in greater detail referring to FIG. 2. The red LED 3 is assigned a photodiode 6. The light of the LED 3 impinges on the photodiode 6. An operational amplifier 11 is connected in parallel with a resistor 12 and forms a current follower downstream of the LED 6. The voltage drop downstream of the operational amplifier 11 is substantially proportional to the luminous intensity of the LED 3. The voltage is converted into a digital signal by means of an analog-to-digital converter 13 and the digital signal is forwarded to a control device 14. The control device 14 drives the LED 3.

The power of the LED 3 is controlled by means of a pulsed operation mode, that is to say that the LED 3 is operated with constant voltage and the power is controlled by the ratio of pulse intermissions and pulse widths. By means of such a control circuit 10, which is provided for all the channels, that is to say, all three colors, both the color temperature and the luminous flux of a luminaire (1 in FIG. 1) can be controlled very precisely.

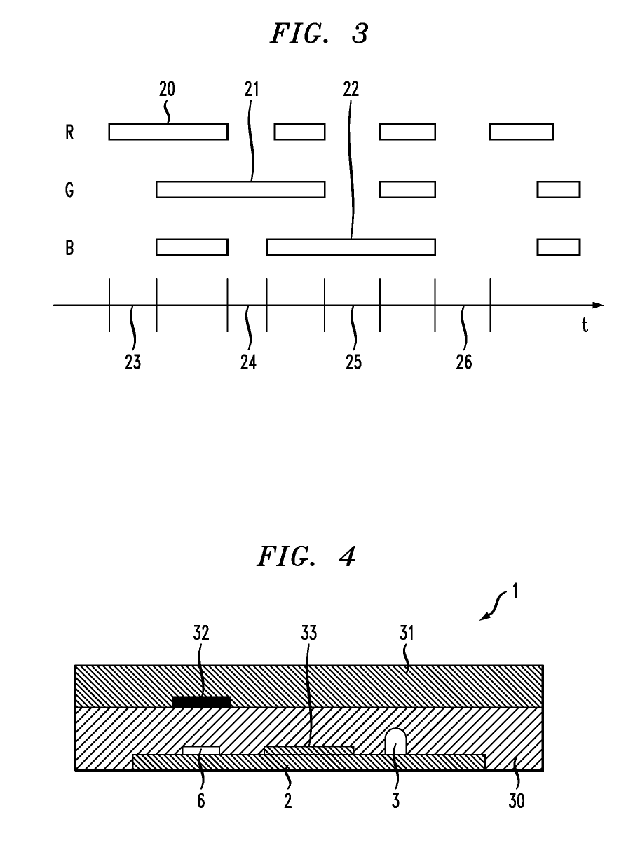

The power control and the control method for power control of the LEDs will be explained in greater detail referring to FIG. 3.

The switch-on times of the individual LEDs are plotted in FIG. 3. 20 shows the switching signal of the red LED, 21 that of the green LED, and 22 that of the blue LED. It can be discerned that firstly a measurement window 23 is provided, in which only the red LED is switched on. The luminous intensity of the red LED can be determined in this measurement window. All three LEDs are then switched on. A measurement window 24 then ensues, in which only the green LED is switched on. Finally, after all three LEDs have been switched on again, a measurement window 25 ensues, in which only the blue LED is switched. A further measurement window 26, in which all the LEDs are switched off, enables a dark field measurement in order to determine the scattered light component. Power control of the LEDs is possible by means of the pulse widths and, in particular, by means of an extension of the dark field measurement window 26. Preferably, the LEDs of a new lamp are operated only with approximately half of their maximum light power, in order to counterbalance aging of the LEDs by extending the pulse widths. In order to prevent flicker of the luminaire, the frequency of the signals for the individual LEDs is preferably at 100 Hz.

FIG. 4 schematically shows a sectional view of an exemplary embodiment of a luminaire 1 according to the invention. A circuit board 2 can be discerned, on which the LEDs and the photodiodes are soldered. The red LED 3 and the assigned photodiode 6 can be seen in this sectional view. An integrated circuit 33 comprising a multichannel analog-to-digital converter (not illustrated), a control device for power control of the LEDs (not illustrated) and also an EPROM in which families of characteristic curves for the control of the luminaire are stored is furthermore situated on the circuit board 2. Said families of characteristic curves may comprise in particular luminous intensity relations of the individual LEDs, a total luminous intensity, a temperature adaptation, etc.

The circuit board 2 is embedded in a potting composition 30, which consists of silicone in this exemplary embodiment. A covering plate 31 is applied to the potting composition. A covering 32 is situated above the LED 6, said covering being spaced apart from the LED 6 by the potting composition 30. In this example, the covering 32 is a reflective layer roughened at the bottom.

The covering 32 reduces the application of ambient light to the LED 6.

The essential steps of a method for controlling a luminaire will be explained referring to FIG. 5.

In a first step, the green and blue LEDs are switched off 40, such that only the red LED emits light and the luminous intensity of the red LED can be measured 41. It goes without saying that the luminous intensity is measured by means of an assigned photodiode in the form of a relative luminous intensity at the location of the photodiode. The luminous flux of the LED can ultimately be deduced by means of said relative luminous intensity. A precise determination of the luminous flux is not necessary since ultimately only a calibration has to be performed. The calibration can either be effected individually for each luminaire, whereby an extremely precise setting of color temperature and brightness is possible. Furthermore, the calibration can also be effected on the basis of a specimen component, which is significantly less complicated.

In a further step, the red and blue LEDs are then switched off 42 and the luminous intensity of the green LED is measured 43.

Finally, the red and green LEDs are switched off 44, and the luminous intensity of the blue LED is measured 45.

Finally, a dark measurement 47 is also effected after all the LEDs have been switched off 46.

On the basis of the measurement of the luminous intensity of all the LEDs and the dark measurement, the power of the LEDs of the different colors is controlled in order to achieve a desired luminous intensity and/or a desired color temperature 48.

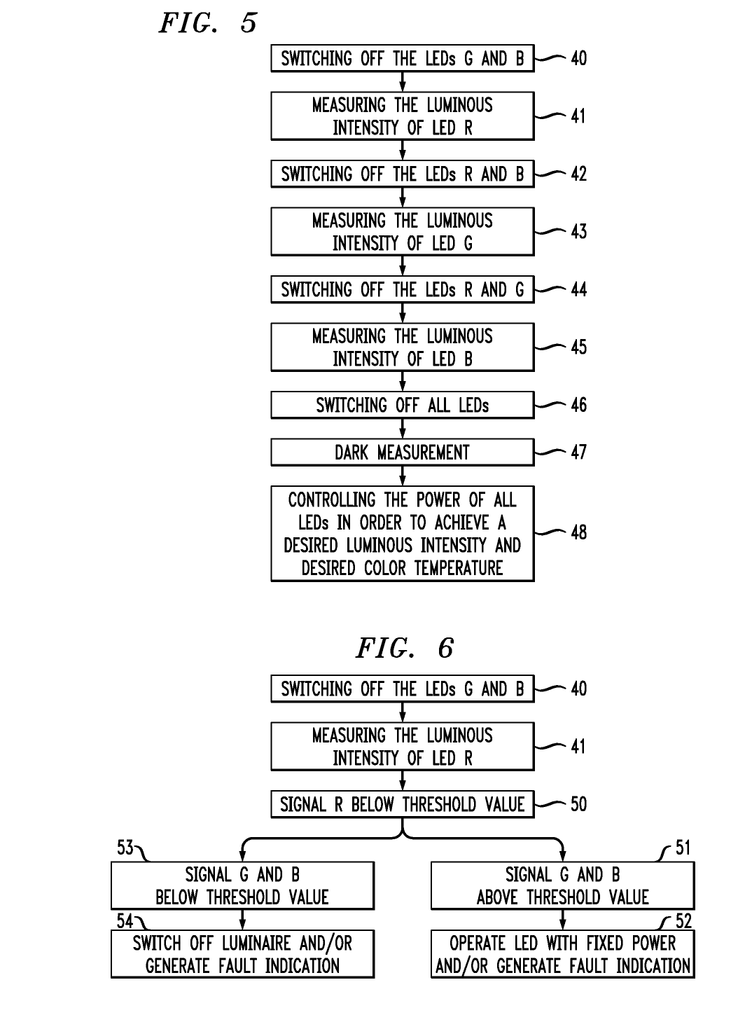

Steps according to the invention for fault detection during operation of a luminaire according to the invention will be explained in greater detail referring to FIG. 6.

In this example, the green and blue LEDs are switched off 40 in order to measure the luminous intensity of the red LED 41.

In this exemplary embodiment, the signal of the photodiode for the red LED lies below a predetermined threshold value 50. From the undershooting of the threshold value it can be deduced that a component of the luminaire is defective.

In order to determine which component is defective, the signals of the green and blue LEDs are simultaneously read out. If the signals of the green and blue LEDs likewise lie below a threshold value 53, it can be deduced from this that the red LED is defective.

On account of the defect, the luminaire is switched off and a fault indication is generated 54, which can be forwarded for example via a data bus.

If, by contrast, the signal of the green and blue LEDs lies above a threshold value 51, it can be deduced from this that the red LED emits light, that is to say is not defective.

In this case, the LEDs are operated with a fixed power; in particular the power which was determined during the last measurement when the circuit was still in order is set and a fault indication is likewise generated 52 in order to instigate a replacement of the luminaire.

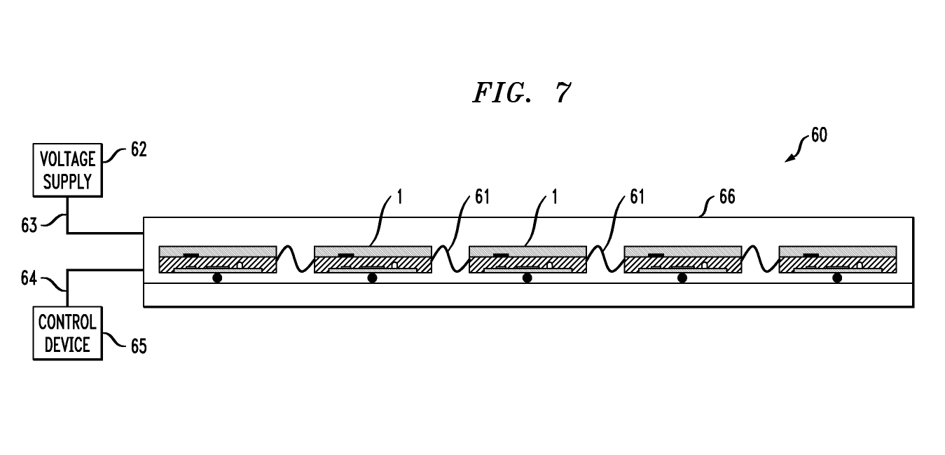

FIG. 7 schematically shows an arrangement 60 comprising a plurality of luminaires 1. The luminaires 1 correspond to the exemplary embodiment illustrated schematically in FIG. 4.

The luminaires 1 are connected to flexible conductor tracks, which are configured in particular as a flexible circuit board, and arranged one after another. By way of example, a flexible hose can be used as housing 66. Since the individual luminaires are connected by means of a flexible conductor track 61, this results in a flexible lighting system.

The current for operating the luminaires 1 is supplied by means of a voltage supply 62 and a line.

Furthermore, the luminaires are connected to a control device 65 via a bus line 64. Fault indications can be forwarded to the control device via the bus line 64. At the same time, color, brightness, etc. of the individual luminaires 1 can be controlled independently of one another by means of the control device 65. Thus, it is also possible, for example, to illuminate individual luminaires 1 as reading lamps, for instance in an aircraft, for example by means of a control device (not illustrated) arranged in the seat. Thus, the individual luminaires can perform a multiplicity of functions, for example as space lighting, as night light, as reading lighting, etc.

In an alternative embodiment, the line 63 for voltage supply can also be used as a data bus line.

A further embodiment of a luminaire 1 according to the invention will be explained in greater detail referring to FIG. 8.

As in FIG. 1, the luminaire comprises three LEDs in the colors red 3, green 4 and blue 5. Each LED 3, 4 and 5 is assigned a photodiode 6, 7, 8, by means of which the luminous intensity of the individual LEDs can be determined.

Both the LEDs 3, 4, 5 and the photodiodes 6, 7, 8 are connected to an integrated circuit 33 formed as a control device for controlling the power of the individual LEDs. The integrated circuit 33 comprises an EPROM with families of characteristic curves for power control.

For further control, each LED is assigned a temperature sensor 70, 71, 72. The temperature sensors 70, 71, 72 are likewise connected to the integrated circuit. Since the color temperature of the individual LEDs 3, 4, 5 changes very rapidly in the event of a temperature change, a change in the color temperature can be avoided by means of the temperature sensors. By contrast, the photodiodes 6, 7, 8 serve primarily to compensate for changes in the luminous intensity of the LEDs 3, 4, 5 on account of aging phenomena.

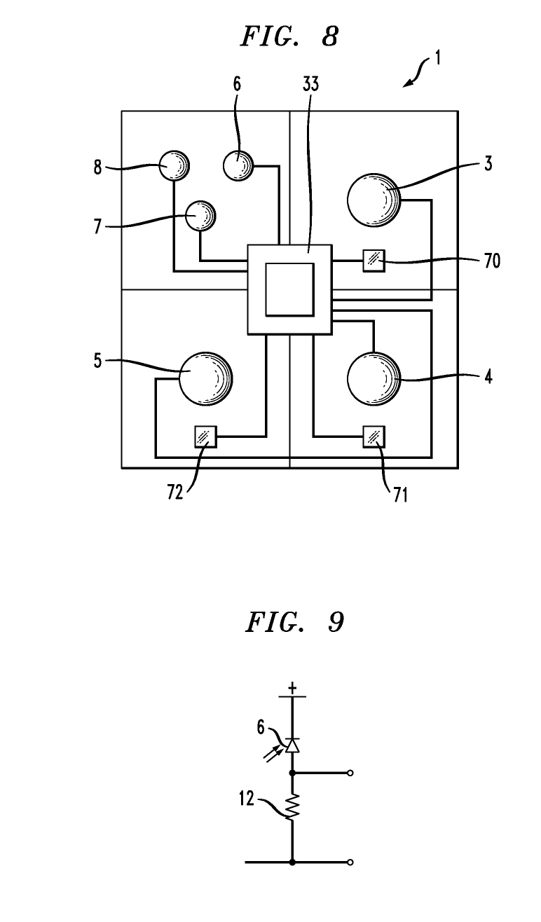

A control circuit that is possible as an alternative to FIG. 2 will be explained referring to FIG. 9.

Here the control circuit comprises a resistor 12 that is connected downstream of the LED 6 and acts as a voltage divider. The voltage tapped off at the resistor is proportional to the signal of the LED 6. The advantage of this circuit is the particularly simple configuration. The building up of a countervoltage, which can lead to noise effects, is disadvantageous.

It goes without saying that the subject matter of the invention is not restricted to a combination of features described above, rather that the person skilled in the art will combine all of the features described as desired in so far as is expedient.

### LIST OF REFERENCE SYMBOLS

1 Luminaire

2 Circuit board

3 LED red

4 LED green

5 LED blue

6 Photodiode red

7 Photodiode green

8 Photodiode blue

9 Ridge

10 Control circuit

11 Amplifier

12 Resistor

13 Analog-to-digital converter

14 Control device

20 Switching signal red

21 Switching signal green

22 Switching signal blue

23 Measurement window red

24 Measurement window green

25 Measurement window blue

26 Measurement window dark measurement

30 Potting composition

31 Covering plate

32 Covering

33 Integrated circuit

40 Switching off green blue

41 Measuring red

42 Switching off red blue

43 Measuring green

44 Switching off red green

43 Measuring blue

46 Switching off all LEDs

47 Dark measurement

48 Controlling the power of all LEDs

50 Signal red below threshold value

51 Signal green and blue above threshold value

52 Operate LED with fixed power and generate fault indication

53 Signal green and blue below threshold value

54 Switch off luminaire and generate fault indication

60 Arrangement comprising luminaires

61 Flexible conductor track

62 Voltage supply

63 Line

64 Bus line

65 Control device

66 Housing

70 Temperature sensor LED red

71 Temperature sensor LED green

72 Temperature sensor LED blue

1. A luminaire comprising:
at least in each case one LED in three different colors,
means for feeding electric current to the LEDs,
means for controlling the electric current for the LEDs of each color,
at least three photodiodes, wherein each color is assigned at least one photodiode,
means for occasionally switching off LEDs in two colors in each case,
wherein during the switch-off time the luminous intensity of the remaining color can be measured via the assigned photodiode,
means for comparing the luminous intensities with one another and/or with desired luminous intensities, and
means for setting the electric current for at least one LED, on the basis of the comparison.

2. The luminaire as claimed in claim 1, wherein the LEDs and the photodiodes are embedded in a transparent potting composition.

3. The luminaire as claimed in claim 1, wherein photodiodes at least partly have a substantially light-opaque covering spaced apart from the photodiodes.

4. The luminaire as claimed in claim 1, wherein the covering is formed in light-scattering fashion at least on the underside.

5. (canceled)

6. The luminaire as claimed in claim 1, wherein the luminaire has at least one optical waveguide leading from at least one photodiode to at least one LED.

7. The luminaire as claimed in claim 1, wherein the luminaire has at least two photodiodes having different characteristic curves.

8. (canceled)

9. The luminaire as claimed in claim 1, wherein the luminaire has means for calibrating the light color and/or light power.

10. The luminaire as claimed in claim 9, wherein the calibration means comprise a data memory.

11. (canceled)

12. The luminaire as claimed in claim 1, wherein each photodiode is assigned at least one amplifier.

13. (canceled)

14. The luminaire as claimed in claim 1, wherein the photodiodes for the different colors have different characteristic curves, which are coordinated with the respective light color.

15. The luminaire as claimed in claim 1, wherein the luminaire can be switched into different colors.

16. (canceled)

17. The luminaire as claimed in claim 1, wherein at least one photodiode has a color filter.

18. (canceled)

19. The luminaire as claimed in claim 1, wherein a temperature sensor is assigned to at least one LED.

20. The luminaire as claimed in claim 1, wherein the luminaire has a memory in which calibration values can be stored.

21. A method for controlling an LED luminaire having at least three LEDs in different colors, the method comprising:
switching off the LEDs in two colors in each case,
measuring the luminous intensity of the remaining switched-on LED during the switch-off time via a photodiode assigned to a respective color,
comparing the luminous intensity with a desired luminous intensity and/or the luminous intensity of the LEDs of another color, and
controlling the power of at least one LED on the basis of the comparison.

22. The method for controlling an LED luminaire as claimed in claim 21, wherein all the LEDs are occasionally switched off and a dark measurement is carried out for correction purposes.

23. The method for controlling an LED luminaire as claimed in claim 21, wherein the temperature of at least one LED is measured and taken into account in the control of the power.

24. A luminaire comprising:
at least in each case one LED in three different colors,
means for feeding electric current to the LEDs,
means for controlling the electric current for the LEDs of each color,
at least two photodiodes, wherein at least two colors are assigned at least one photodiode,
means for occasionally switching off LEDs in two colors in each case,
wherein during the switch-off time the luminous intensity of the remaining color can be measured via the assigned photodiode,
means for comparing the luminous intensities with one another and/or with desired luminous intensities, and
means for setting the electric current for at least one LED on the basis of the comparison,
and wherein during the switch-off time the voltage also of at least one non-assigned LED can be measured and the luminaire has means for switching-off and/or for fault indication.

25. The luminaire as claimed in claim 24, having at least three photodiodes, wherein each color is assigned to at least one photodiode.

26. The luminaire as claimed in claim 24, wherein the luminaire can be switched into an operating state with constant power in the case of a defective photodiode.

27. The luminaire as claimed in claim 24, wherein the means for fault indication comprise an optical signal of at least one LED.

28. A luminaire comprising:
at least in each case one LED in three different colors,
means for feeding electric current to the LEDs,
means for controlling the electric current for the LEDs of each color,
at least one photodiode for measuring the luminous intensity of at least one LED, and
means for setting the electric current for at least one LED, wherein the luminaire has a covering spaced apart from the photodiode.
